(19) United States
(12) Patent Application Publication
(10) Pub. No.: US 2020/0231737 A1
(43) Pub. Date: Jul. 23, 2020

(54) PROCESS FOR PRODUCING POLYURETHANE BOOTS

(71) Applicant: BASF SE, Ludwigshafen am Rhein (DE)

(72) Inventors: Amir Doroodian, Lemfoerde (DE); Marco Ortalda, Villanova d'Asti (IT); Cristian Baravalle, Villanova d'Asti (IT); Robert Frenzel, Lemfoerde (DE)

(21) Appl. No.: 16/489,744

(22) PCT Filed: Mar. 7, 2018
(86) PCT No.: PCT/EP2018/055632

§ 371 Date: Aug. 29, 2019

(30) Foreign Application Priority Data
Mar. 16, 2017 (EP) 17161328.4

(51) Int. Cl. C08G 18/42; C08G 18/10; C08G 18/18; C08G 18/48; C08G 18/24; A43B 1/14

(52) U.S. Cl. CPC C08G 18/4238; C08G 18/10; C08G 18/1808; C08G 2101/0066; C08G 18/246; A43B 1/14; C08G 18/4808

(57) ABSTRACT

Disclosed is a process for producing polyurethane boots. The method includes mixing organic polyisocyanates with a combination of polyols, a chain extender, a blowing agent, a catalyst, and optionally other auxiliaries and/or additives. The resulting reaction mixture is introduced, in only one injection, into a mold including a sole and an upper of the mold and allowed to react to form a polyurethane boot. At least one catalyst including a tertiary amine and sebacic acid is employed in a molar ratio of 1:0.19 to 0.27.

### DESCRIPTION

The present invention relates to a process for producing polyurethane boots wherein
a) organic polyisocyanates are mixed with
b) polyols,
c) chain extender,
d) blowing agent,
e) catalyst and
f) optionally other auxiliaries and/or additives

to afford a reaction mixture and in only one injection introduced into a mold comprising the sole and the upper of the boot and allowed to react to form a polyurethane boot, wherein at least one catalyst comprising a tertiary amine and sebacic acid is employed in a molar ratio of tertiary amine to sebacic acid of 1:0.19 to 0.27.

Polyurethane (PU) boots typically consist of two different parts: the upper and the sole. In the hitherto-known processes for producing PU boots the sole and the upper are respectively produced by separate injection of the material into the mold. The formulations for the upper and the sole differ and each of these parts requires a certain curing time before injection of the other part. This processing results in slow production higher production costs and in some cases the boots have problems with adhesion between the upper and the sole.

The present invention has for its object to develop a PU system that can produce the complete boot with one shot into the mold. To this end the cream time (commencement of the reaction) must be longer than the injection time into the mold and the flowability of the reactive mixture must be suitable for the application, since the mixture must fill the complete upper in the alloted time. To this end, the cream time of the foam system should be more than 15 sec. In addition, the material should be cured in less than 7 minutes to ensure useful productivity and the demolding time and the flex time should be as short as possible.

The process described at the outset surprisingly solves this demanding problem, wherein the catalyst employed is a mixture of a tertiary amine and sebacic acid.

EP-A 989 146 generally describes catalyst systems for producing polyurethanes which consist of tertiary amines and aliphatic dicarboxylic acids. However, the therein-described molar ratios of tertiary amine to dicarboxylic acid of 1:0.4 to 1:1 are not suitable for the process according to the invention.

The process according to the invention is more particularly described hereinbelow: The PU boots according to the invention are elastomeric polyurethane foams, preferably polyurethane integral foams. In the context of the present invention, elastomeric polyurethane foam is be understood as meaning polyurethane foams according to DIN 7726 which after brief deformation by 50% of their thickness according to DIN 53 577 show no lasting deformation above 5% of their starting thickness after 10 minutes. In the context of the present invention, polyurethane integral foams are to be understood as meaning polyurethane foams according to DIN 7726 having an edge zone that has a higher density than the core as a consequence of the molding process. The total apparent density averaged over the core and the end zone is by preference between 150 g/l and 950 g/l, preferably from 300 g/l to 800 g/l, particularly preferably 350 g/l to 700 g/l.

The organic and/or modified polyisocyanates (a) used for producing the polyurethane foam moldings according to the invention comprise the aliphatic, cycloaliphatic and aromatic di- or polyfunctional isocyanates known from the prior art (constituent (a-1)) and any desired mixtures thereof. Examples are methanediphenyl diisocyanate (MDI), tetramethylene diisocyanate, hexamethylene diisocyanate (HDI), isophorone diisocyanate (IPDI), 2,4- or 2,6-tolylene diisocyanate (TDI) or mixtures of the recited isocyanates. MDI comprises monomeric methanediphenyl diisocyanate (MMDI), such as 4,4′-methanediphenyl diisocyanate, 2,4′-methanediphenyl diisocyanate, and the mixtures of monomeric methanediphenyl diisocyanates and polynuclear homologs of methanediphenyl diisocyanate (polymeric MDI).

4,4′-MDI is preferably employed. The preferably employed 4,4′-MDI may comprise 0% to 20% by weight of 2,4-MDI and small amounts, up to about 10% by weight, of allophanate-, carbodiimide- or uretonimine-modified 4,4′-MDI. Also employable in addition to 4,4′-MDI are small amounts of 2,4′-MDI and/or polyphenylene polymethylene polyisocyanate (polymeric MDI). The total amount of these high-functionality polyisocyanates should not exceed 5% by weight of the employed isocyanate.

The isocyanates a1) may be employed directly or in the form of their prepolymers. These polyisocyanate prepolymers are obtainable by reacting above-described polyisocyanates (a-1), for example at temperatures of 30° C. to 100° C., preferably at about 80° C., with compounds having at least two isocyanate-reactive hydrogen atoms (a-2) to afford the prepolymer.

Suitable compounds having at least two isocyanate-active groups (a-2) include the polyols b described hereinbelow which are known to those skilled in the art and described for example in “Kunststoffhandbuch, Band 7, Polyurethane” [Plastics Handbook, Volume 7, Polyurethanes], Carl Hanser Verlag, 3rd edition 1993, Chapter 3.1. It is preferable when the polyester polyols described under b1) are employed. It is preferable when the MDI or the prepolymers of MDI comprise more than 80% by weight of 4,4′-MDI based on the total weight of the MDI including the MDI used for producing the prepolymers. The MDI preferably comprises 0.5% to 10% by weight of carbodiimide-modified MDI, in particular carbodiimide-modified 4,4′-MDI.

The polyols (b) comprise polyester polyols (b1) and polyetherols (b2). Employable polyester polyols (b1) are polyester polyols having at least two isocyanate-reactive hydrogen atoms. Polyester polyols preferably have a number-average molecular weight of more than 450 g/mol, particularly preferably of more than 500 to less than 8000 g/mol and in particular of 600 to 3500 g/mol, and a functionality of 2 to 4, in particular of 2 to 3.

Polyester polyols (b1) are producible for example from organic dicarboxylic acids having 2 to 12 carbon atoms, preferably aliphatic dicarboxylic acids having 4 to 10 and in particular 4 to 6 carbon atoms, and polyhydric alcohols, preferably diols, having 2 to 12 carbon atoms, preferably 2 to 6 carbon atoms. Contemplated dicarboxylic acids include for example: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids may be used either individually or in admixture with one another. Instead of the free dicarboxylic acids it is also possible to use the corresponding dicarboxylic acid derivatives, for example dicarboxylic esters of alcohols having 1 to 4 carbon atoms or dicarboxylic anhydrides. It is preferable to use dicarboxylic acid mixtures of succinic acid, glutaric acid and adipic acid in quantitative ratios of for example 20 to 35:35 to 50:20 to 32 parts by weight and in particular adipic acid. Examples of di- and polyhydric alcohols, in particular diols, are: ethanediol, diethylene glycol, 1,2- and 1,3-propanediol, dipropylene glycol, 1,4-butanediol, 1,5-pentanediol, 1,6-hexanediol, 1,10-decanediol, glycerol and trimethylolpropane. It is preferable to use ethanediol, diethylene glycol, 1,4-butanediol, 1,5-pentanediol and 1,6-hexanediol. It is also possible to use polyester polyols composed of lactones, for example ε-caprolactone, or hydroxycarboxylic acids, for example ω-hydroxycaproic acid.

To produce the polyester polyols (b1) the organic, for example aromatic and preferably aliphatic, polycarboxylic acids and/or derivatives and polyhydric alcohols may be polycondensed down to the desired acid number which is preferably less than 10, particularly preferably less than 2, without catalyst or preferably in the presence of esterification catalysts, advantageously in an atmosphere of inert gas, for example nitrogen, carbon monoxide, helium, argon inter alia, in the melt at temperatures of 150 to 250° C., preferably 180 to 220° C., optionally under reduced pressure. In a preferred embodiment the esterification mixture is polycondensed down to an acid number of 80 to 30, preferably 40 to 30, at the abovementioned temperatures under standard pressure, and subsequently under a pressure of less than 500 mbar, preferably 50 to 150 mbar.

Contemplated esterification catalysts include for example iron catalysts, cadmium catalysts, cobalt catalysts, lead catalysts, zinc catalysts, antimony catalysts, magnesium catalysts, titanium catalysts and tin catalysts, in the form of metals, metal oxides or metal salts. However, the polycondensation can also be conducted in the liquid phase in the presence of diluents and/or entraining agents, for example benzene, toluene, xylene or chlorobenzene, for azeotropic distillative removal of the water of condensation. To produce the polyester polyols, the organic polycarboxylic acids and/or derivatives and polyhydric alcohols are advantageously polycondensed in a molar ratio of 1:1 to 1.8, preferably 1:1.05 to 1.2.

Suitable polyester polyols (b1) further include polymer-modified polyester polyols, preferably graft polyester polyols. Concerned here is a so-called polymer polyester polyol which typically has a content of, preferably thermoplastic, polymers of 5% to 60% by weight, preferably 10% to 55% by weight, particularly preferably 15% to 50% by weight and in particular 20% to 40% by weight These polymer polyester polyols are described in WO 05/098763 and EP-A-250 351 for example and are typically produced by free-radical polymerization of suitable olefinic monomers, for example styrene, acrylonitrile, (meth)acrylates, (meth)acrylic acid and/or acrylamide in a polyester polyol which serves as a graft substrate. In addition to the graft copolymer the polymer polyol predominantly comprises the homopolymers of the olefins, dispersed in unchanged polyester polyol.

In a preferred embodiment, monomers employed are acrylonitrile, styrene, preferably acrylonitrile and styrene. The monomers are polymerized in a polyester polyol as a continuous phase optionally in the presence of further monomers, of a macromer, i.e. of an unsaturated, free-radically polymerizable polyol, of a moderator, and using a free-radical initiator, usually azo or peroxide compounds. This process is described in U.S. Pat. Nos. 3,304,273, 3,383,351, 3,523,093, DE 1 152 536 and DE 1 152 537 for example.

The macromers are also incorporated into the copolymer chain during the free-radical polymerization. This forms block copolymers having a polyester block and a poly(acrylonitrile-styrene) block which act as compatibilizers at the interface between the continuous phase and the disperse phase and inhibit agglomeration of the polymer polyesterol particles. The proportion of macromers is typically 1% to 20% by weight based on the total weight of the monomers used for preparing the polymer polyol.

If polymer polyester polyol is present it is preferably present together with further polyester polyols. It is particularly preferable when the proportion of polymer polyol is more than 5% by weight based on the total weight of the component (b). The polymer polyester polyols may be present for example in an amount of 7% to 90% by weight or of 11% to 80% by weight based on the total weight of the component (b).

Also employable in addition to polyester polyols (b1) are further polyols customary in polyurethane chemistry having a number-average molecular weight of more than 500 g/mol, for example polyetherols (b2). However, the proportion of further polyols is preferably less than 40% by weight, particularly preferably less than 20% by weight, very particularly preferably less than 10% by weight, more preferably less than 5% by weight and in particular 0% by weight based on the total weight of polyester polyols (b) and the further polyols.

The polyether polyols (b2) may also be employed instead of the polyester polyols (b1). Employed as polyether polyols (b2) are polyether polyols having an average functionality of greater than 2.0. Suitable polyether polyols may be produced from one or more alkylene oxides having preferably 2 to 4 carbon atoms in the alkylene radical by known processes, for example by anionic polymerization with alkali metal hydroxides, such as sodium or potassium hydroxide, or alkali metal alkoxides, such as sodium methoxide, sodium or potassium ethoxide, or potassium isopropoxide or by cationic polymerization with Lewis acids such as antimony pentachloride and boron fluoride etherate as catalysts and with the addition of at least one starter molecule which preferably comprises 2 to 4 reactive hydrogen atoms in bonded form.

Suitable alkylene oxides are for example 1,3-propylene oxide, 1,2- and 2,3-butylene oxide and preferably ethylene oxide and 1,2-propylene oxide. The alkylene oxides may be used individually, in alternating succession, or in the form of mixtures. Contemplated starter molecules include for example water or di- and trihydric alcohols, such as ethylene glycol, 1,2- and 1,3-propanediol, diethylene glycol, dipropylene glycol, 1,4-butanediol, glycerol or trimethylolpropane.

The polyether polyols (b2), preferably polyoxypropylene and polyoxypropylene-polyoxyethylene polyols, have an average functionality of preferably 2.01 to 3.50, particularly preferably 2.25 to 3.10 and very particularly preferably of 2.4 to 2.8. Employed in particular are polyether polyols obtained exclusively from trifunctional starter molecules. The molecular weights of the polyether polyols (b2) are preferably 1000 to 10 000 g/mol, particularly preferably 1800 to 8000 g/mol and in particular 2400 to 6000 g/mol.

It is preferable to employ polyether polyols (b2) based on propylene oxide and comprising terminally bonded ethylene oxide units. The content of terminally bonded ethylene oxide units is preferably 10% to 25% by weight based on the total weight of the polyether polyol (b2).

Employed as polymer polyether polyols (b2) are polyether polyols typically having a content of preferably thermoplastic polymers of 5% to 60% by weight, preferably 10% to 55% by weight, particularly preferably 30% to 55% by weight and in particular 40% to 50% by weight. These polymer polyether polyols are known and commercially available and are typically produced by free-radical polymerization of olefinically unsaturated monomers, preferably acrylonitrile, styrene, and optionally of further monomers, of a macromer and optionally of a moderator using a free-radical initiator, usually azo or peroxide compounds, in a polyetherol as the continuous phase. The polyetherol constituting the continuous phase is often referred to as a carrier polyol. For the production of polymer polyols reference may hereby be made for example to the patent publications U.S. Pat. Nos. 4,568,705, 5,830,944, EP 163188, EP 365986, EP 439755, EP 664306, EP 622384, EP 894812 and WO 00/59971.

This is typically an in situ polymerization of acrylonitrile, styrene or preferably mixtures of styrene and acrylonitrile, for example in a weight ratio of 90:10 to 10:90, preferably 70:30 to 30:70.

Suitable carrier polyols include all polyether-based polyols, preferably those as described under b). Macromers, also described as stabilizers, are linear or branched polyetherols having molecular weights of not less than 1000 g/mol and comprising at least one terminal, reactive olefinically unsaturated group. The ethylenically unsaturated group may be joined to an existing polyol by reaction with carboxylic anhydrides, such as maleic anhydride, fumaric acid, acrylate and methacrylate derivatives and isocyanate derivatives, such as 3-isopropenyl-1,1-dimethylbenzyl isocyanate, isocyanatoethyl methacrylate. A further route is the production of a polyol by alkoxydation of propylene oxide and ethylene oxide using starter molecules having hydroxyl groups and an ethylenic unsaturation. Examples of such macromers are described in the documents U.S. Pat. Nos. 4,390,645, 5,364,906, EP 0461800, U.S. Pat. Nos. 4,997,857, 5,358,984, 5,990,232, WO 01/04178 and U.S. Pat. No. 6,013,731.

The macromers are also incorporated into the copolymer chain during the free-radical polymerization. This forms block copolymers having a polyether block and a poly(acrylonitrile-styrene) block which act as compatibilizers at the interface between the continuous phase and the disperse phase and inhibit agglomeration of the polymer polyol particles. The proportion of macromers is typically 1% to 15% by weight, preferably 3% to 10% by weight, based on the total weight of the monomers used to produce the polymer polyol.

Typically employed for producing polymer polyols are moderators also known as chain transfer agents. By chain transfer of the growing free radical the moderators reduce the molecular weight of the incipient copolymers, thus reducing crosslinking between the polymer molecules and influencing the viscosity and dispersion stability as well as the filterability of the polymer polyols. The proportion of moderators is typically 0.5% to 25% by weight based on the total weight of the monomers used for preparing the polymer polyol. Moderators typically used for producing polymer polyols are alcohols, such as 1-butanol, 2-butanol, isopropanol, ethanol, methanol, cyclohexane, toluene, mercaptans, such as ethanethiol, 1-heptanethiol, 2-octanethiol, 1-dodecanethiol, thiophenol, 2-ethylhexyl thioglycolates, methyl thioglycolates, cyclohexyl mercaptan and enol ether compounds, morpholines and a-(benzoyloxy)styrene. It is preferable to use alkyl mercaptan.

Typically employed for initiation of the free-radical polymerization are peroxide or azo compounds, such as dibenzoyl peroxide, lauroyl peroxide, t-amyl peroxy-2-ethylhexanoate, di-tertbutyl peroxide, diisopropyl peroxide carbonate, tert-butyl peroxy-2-ethylhexanoate, tert-butyl perpivalate, tert-butyl perneodecanoate, tert-butyl perbenzoate, tert-butyl percrotonate, tert-butyl perisobutyrate, tert-butyl peroxy-1-methylpropanoate, tert-butyl peroxy-2-ethylpentanoate, tert-butyl peroxyoctanoate and di-tert-butyl perphthalate, 2,2′-azobis(2,4-dimethylvaleronitrile), 2,2′-azobisisobutyronitrile (AIBN), dimethyl-2,2′-azobisisobutyrate, 2,2′-azobis(2-methylbutyronitrile) (AMBN), 1,1′-azobis(1-cyclohexanecarbonitrile). The proportion of initiators is typically 0.1% to 6% by weight based on the total weight of the monomers used for preparing the polymer polyol.

Due to the reaction rate of the monomers and the half-life of the initiators, the free radical polymerization for producing polymer polyols is typically performed at temperatures of 70° C. to 150° C. and a pressure up to 20 bar. Preferred reaction conditions for producing polymer polyols are temperatures of 80° C. to 140° C. at a pressure of atmospheric pressure to 15 bar.

Polymer polyols are produced in continuous processes using stirred tanks with continuous feeding and discharging, stirred tank cascades, tubular reactors and loop reactors having continuous feeding and discharging or in discontinuous processes using a batch reactor or a semibatch reactor.

It is preferable when the proportion of polymer polyether polyol (b2) is greater than 5% by weight based on the total weight of the component (b). The polymer polyether polyols may be present for example in an amount of 7% to 90% by weight or of 11% to 80% by weight based on the total weight of the components (b).

The polyurethane component according to the invention may further comprise so-called chain extenders and/or crosslinking agents (c). Chain extenders and/or crosslinking agents are to be understood as meaning substances having a molecular weight of preferably less than 450 g/mol, particularly preferably of 60 to 400 g/mol, wherein chain extenders have 2 isocyanate-reactive hydrogen atoms and crosslinking agents have 3 isocyanate-reactive hydrogen atoms.

These may preferably be used individually or in the form of mixtures. It is preferable to employ diols and/or triols having molecular weights of less than 400, particularly preferably of 60 to 300 and in particular 60 to 150. Contemplated are for example aliphatic, cycloaliphatic and/or araliphatic diols having 2 to 14, preferably 2 to 10, carbon atoms, such as ethylene glycol, 1,3-propanediol, 1,10-decanediol, 1,2-, 1,3-, 1,4-dihydroxycyclohexane, diethylene glycol, dipropylene glycol and 1,4-butanediol, 1,6-hexanediol and bis-(2-hydroxyethyl)hydroquinone, triols such as 1,2,4-, 1,3,5-trihydroxycyclohexane, glycerol and trimethylolpropane and low molecular weight hydroxyl-containing polyalkylene oxides based on ethylene oxide and/or 1,2-propylene oxide and the abovementioned diols and/or triols as starter molecules. Particularly preferred as chain extenders (f) are monoethylene glycol, 1,4-butanediol, diethylene gycol, glycerol or mixtures thereof.

If chain extenders, crosslinkers or mixtures thereof (c) are used these are advantageously employed in amounts of 1% to 40% by weight, preferably 1.5% to 20% by weight and in particular 2% to 10% by weight based on the total weight of the components (b) to (f).

Also present in the production of polyurethane foam moldings are blowing agents d). These blowing agents d) may comprise water. Employable as blowing agents d) are not only water but also well known chemically acting and/or physically acting compounds. Chemical blowing agents are to be understood as meaning compounds which form gaseous products, for example water or formic acid, by reaction with isocyanate. Physical blowing agents are to be understood as meaning compounds which are dissolved or emulsified in the starting materials for the production of polyurethane and vaporize under the conditions of polyurethane formation. These include for example hydrocarbons, halogenated hydrocarbons and other compounds, such as for example perfluorinated alkanes, such as perfluorohexane, chlorofluorocarbons, and ethers, esters, ketones, acetals or mixtures thereof, for example (cyclo)aliphatic hydrocarbons having 4 to 8 carbon atoms, or hydrofluorocarbons, such as Solkane® 365 mfc from Solvay Fluorides LLC. A preferred embodiment employs as the blowing agent a mixture comprising at least one of these blowing agents and water, in particular water as the sole blowing agent. If water is not employed as a blowing agent it is preferable to employ exclusively physical blowing agents.

In a preferred embodiment the content of water is from 0.1% to 2% by weight, preferably 0.2% to 1.5% by weight, particularly preferably 0.3% to 1.2% by weight, based on the total weight of the components (b) to (f).

In a further preferred embodiment hollow microspheres comprising physical blowing agent are added to the reaction of the components (a) to (f) as an additional blowing agent. The hollow microspheres may also be employed in admixture with the abovementioned blowing agents.

The hollow microspheres typically consist of a shell of thermoplastic polymer and a core filled with a liquid, low-boiling substance based on alkanes. The production of such hollow microspheres is described for example in U.S. Pat. No. 3,615,972. The hollow microspheres generally have a diameter of 5 to 50 μm. Examples of suitable hollow microspheres are obtainable from Akzo Nobel under the trade name Expancell®.

The hollow microspheres are preferably employed in an amount of 0.5% to 5% by weight based on the total weight of the components (b) to (f).

As catalysts (e) for producing the polyurethane boots it is preferable to employ compounds which strongly accelerate the reaction of the polyols (b) with the organic, optionally modified polyisocyanates (a). A combination of at least one tertiary amine (e1) and sebacic acid (e2) is employed as catalysts (e). Further catalysts (e3) may also be used.

The molar ratio of the tertiary amine e1 to the sebacic acid e2 is 1:0.19 to 0.27.

Tertiary amines (e1) are to be understood as meaning for example triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, pentamethyldipropylenetriamine, tetramethyldiaminoethyl ether, bis(dimethylaminopropyl) urea, dimethylpiperazine, 1,2-dimethylimidazole, alkanolamine compounds, such as triethanolamine, triisopropanolamine, N-methyl- and N-ethyldiethanolamine and dimethylethanolamine, 1-azabicyclo-(3,3,0)-octane and preferably pentamethyldiethylenetriamine, pentamethyldipropylenetriamine and especially preferably 1,4-diazabicyclo-(2,2,2)-octane (DABCO; also referred to hereinbelow as triethylenedamine).

If polyesterols (b1) are used as the polyols (b), triethylenediamine in particular has proven advantageous. In these polyol components the tertiary amine is employed in an amount of generally 0.2% to 1% by weight and preferably 0.3% to 0.5% by weight based on the weight of the components (b) to (f).

If polyetherols (b2) are used as polyols (b), triethylenediamine, pentamethyldiethylenetriamine and pentamethyldipropylenetriamine or in particular a combination of triethylenediamine and pentamethyldipropylenetriamine have proven advantageous in particular. In these polyol components the tertiary amine is employed in an amount of generally 0.6% to 1.3% by weight and preferably 0.8% to 1.2% by weight based on the weight of the components (b) to (f).

Contemplated as additional catalysts (e3) are for example organic metal compounds, preferably organic tin compounds, such as tin(II) salts of organic carboxylic acids, for example tin(II) acetate, tin(II) octoate, tin(II) ethylhexoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof.

It is preferable when the additional catalysts (e3) are employed in 0.001% to 0.5% by weight, in particular 0.01% to 0.1% by weight, based on the weight of the components (b) to (f).

It is also possible to add auxiliaries and/or additives (f) to the reaction mixture for producing the polyurethane foams. These include for example release agents, fillers, dyes, pigments, anti-hydrolysis agents, antistatic additives, odor-absorbing substances and fungistatic and/or bacteriostatic substances.

Suitable release agents include for example: reaction products of fatty acid esters with polyisocyanates, salts of amino-comprising polysiloxanes and fatty acids, salts of saturated or unsaturated (cyclo)aliphatic carboxylic acids having at least 8 carbon atoms and tertiary amines, and in particular internal release agents, such as carboxylic esters and/or amides produced by esterification or amidation of a mixture of montanic acid and at least one aliphatic carboxylic acid having at least 10 carbon atoms with at least difunctional alkanolamines, polyols and/or polyamines having molecular weights of 60 to 400 g/mol as disclosed for example in EP 153 639, mixtures of organic amines, metal salts of stearic acid and organic mono- and/or dicarboxylic acids or anhydrides thereof as described for example in DE-A-3 607 447, or mixtures of an imino compound, the metal salt of a carboxylic acid and optionally a carboxylic acid as disclosed for example in U.S. Pat. No. 4,764,537. It is preferable when the reaction mixtures according to the invention comprise no further release agents.

Fillers, in particular reinforcing fillers, are to be understood as meaning the known-per-se, customary organic and inorganic fillers, reinforcers, weighting agents, coating compositions etc.

Specific examples include: inorganic fillers such as siliceous minerals, for example phyllosilicates such as antigorite, bentonite, serpentine, hornblends, amphiboles, chrysotile and talc, metal oxides, such as kaolin, aluminum oxides, titanium oxides, zinc oxide and iron oxides, metal salts such as chalk and barite, and inorganic pigments such as cadmium sulfide, zinc sulfide and also glass and the like. It is preferable to employ kaolin (china clay), aluminum silicate and co-precipitates of barium sulfate and aluminum silicate. Contemplated organic fillers include for example: carbon black, melamine, colophony, cyclopentadienyl resins and graft polymers and also cellulose fibers, polyamide fibers, polyacrylonitrile fibers, polyurethane fibers, polyester fibers based on aromatic and/or aliphatic dicarboxylic esters and in particular carbon fibers. The inorganic and organic fillers may be used individually or as mixtures and are advantageously added to the reaction mixture in amounts of 0.5% to 50% by weight, preferably 1% to 40% by weight, based on the weight of the components (a) to (f).

The stability to hydrolysis of polyester polyurethanes may be markedly improved by addition of additives, such as carbodiimides. Such materials are commercially available under trade names such as for example Elastostab™ or Stabaxol™.

Employable antistatic additives include customary antistatic additives known for polyurethanes. These comprise quaternary ammonium salts and ionic liquids.

In the process according to the invention the starting components (a) to (f) are mixed with one another in amounts such that the theoretical equivalent ratio of NCO groups of the polyisocyanates (a) to the sum of the reactive hydrogen atoms of the components (b) to (e) and (f) is 1:0.8 to 1:1.25, preferably from 1:0.9 to 1:1.15. A ratio of 1:1 corresponds to an isocyanate index of 100. In the context of the present invention the isocyanate index is to be understood as meaning the stoichiometric ratio of isocyanate groups to isocyanate-reactive groups multiplied by 100.

The present invention further provides a polyurethane molding obtainable by the process according to the invention.

The polyurethane moldings according to the invention are preferably produced by the one-shot process using the low-pressure or high-pressure technique in closed, advantageously temperature-controlled molds. The molds are preferably made of metal, for example aluminum or steel. These process approaches are described for example by Piechota and Rohr in “Inte-gralschaumstoff” [Integral foam], Carl-Hanser-Verlag, Munich, Vienna, 1975, or in “Kunststoff-handbuch” [Plastics Handbook], volume 7, Polyurethanes, 3rd edition, 1993, Chapter 7.

To this end the starting components (a) to (f) are preferably mixed at a temperature of 15° C. to 90° C., particularly preferably of 25° C. to 55° C., and the reaction mixture is introduced into the mold optionally at elevated pressure. Mixing may be performed mechanically using a stirrer or a stirring screw or under high pressure in the so-called countercurrent injection process. The mold temperature is advantageously 20° C. to 160° C., preferably 30° C. to 120° C., particularly preferably 30° C. to 60° C. In the context of the invention the mixture of the components (a) to (f) is referred to as the reaction mixture at reaction conversions of less than 90% based on the isocyanate groups.

The amount of the reaction mixture introduced into the mold is measured such that the obtained moldings, in particular integral foam, have a density of preferably 150 g/L to 950 g/L, preferably of 300g/L to 800 g/L, particularly preferably 350 g/L to 700 g/L. The degrees of packing for producing the polyurethane integral foams according to the invention are in the range from 1.1 to 4, preferably from 1.6 to 3.

It is preferable to employ the two-component process. This comprises mixing an isocyanate component with a polyol component. The isocyanate component comprises the isocyanates (a) and the polyol component (b) comprises the chain extender (c) and, to the extent that chemical blowing agents such as for example water are employed, blowing agents (d). The polyol component preferably further comprises the catalysts (e). The auxiliaries and additives (f) are preferably added to the polyol component as well. The component (e) may be added either to the isocyanate component or to the polyol component. The polyol component is storage stable and does not undergo demixing. To produce the polyurethane moldings according to the invention the isocyanate component and the polyol component are then mixed and processed as described hereinabove.

The process according to the invention is suitable for producing cost-effective polyurethane boots. In principle polyurethane foams according to the invention may also be used in the interiors of modes of transport, for example in automobiles as steering wheels, headrests or shift levers or as armrests. Further applications are armrests for chairs or motorcycle seats. Further possible applications include sealing compositions, damping mats, footfall sound insulation, ski shoe construction elements or applications used in relatively cold conditions. Polyurethane moldings according to the invention show exceptional mechanical properties, in particular an exceptional low-temperature flexibility, exceptional mechanical properties after storage under hot and humid conditions and low abrasion.

The invention will be illustrated below with reference to examples.

In examples 1 and 2 the process according to the invention was investigated using a DESMA machine for boots. The volume of the boot mold was 1.13 liters. 850 g of PU material were required to achieve the required foam density of the boot. A discharge rate of 550 g/sec resulted in a fill time of the boot of 15 sec.

### EXAMPLE 1 (polyesterol (b1)-based)

The following compounds were employed:
Iso a-1: isocyanate prepolymer from BASF based on 4.4-MDI, modified isocyanates and a mixture of polyesterols having a functionality of 2 and an OH number of 56 mg KOH/g with diethyl oxalate as an additive
Polyesterol (b1-1): polyesterol based on adipic acid, monoethylene glycol and diethylene glycol having an OH number of 56 mg KOH/g
KV c-1: monoethylene glycol
Cat e1-1: triethylenediamine in monoethylene glycol (33% by weight)
Cat e2-1: triethylenediamine (25.5% by weight) in ethylene glycol (59% by weight), sebacic acid (13.5% by weight) and water (2% by weight)
Cat e2-2: triethylenediamine (33.7% by weight) in ethylene glycol (50.8% by weight), sebacic acid (13.5% by weight) and water (2% by weight)
Cat e2-3: triethylenediamine (19.5% by weight) in ethylene glycol (65.0% by weight), sebacic acid (13.5% by weight) and water (2% by weight)
Additive f-1: polysiloxane silicone

TABLE 1

| | VB1-1 | B1-2 | B1-3 | B1-4 | B1-5 | B1-6 | B1-7 |
|---|---|---|---|---|---|---|---|
| Polyol b1-1 | 91.97 | 91.97 | 91.97 | 91.97 | 91.97 | 91.97 | 91.97 |
| KVc-1 | 5.50 | 5.50 | 5.50 | 5.50 | 5.50 | 5.50 | 5.50 |
| Cat e1-1 | 0.50 | 0.50 | 0.50 | 0.50 | 0.20 | 0.20 | 0.20 |
| Cat e2-1 | 0.00 | 0.56 | 1.06 | 1.36 | 0.90 | | |
| Cat e2-2 | | | | | | 0.90 | |
| Cat e2-3 | | | | | | | 0.90 |
| Amine/sebacic | 1:0 | 1:0.13 | 1:0.18 | 1:0.20 | 1:0.23 | 1:0.18 | 1:0.28 |
| acid molar ratio | | | | | | | |
| % by wt Amine* | 0.16 | 0.31 | 0.43 | 0.51 | 0.30 | 0.37 | 0.25 |
| Additive f-1 | 0.28 | 0.28 | 0.28 | 0.28 | 0.28 | 0.28 | 0.28 |
| Water | 0.26 | 0.26 | 0.26 | 0.26 | 0.26 | 0.26 | 0.26 |
| MR to Iso a-1 | 100/69.9 | 100/72.1 | 100/74.1 | 100/75.3 | 100/72.3 | 100/71.8 | 100/72.6 |

*based on the components (b) to (f)

TABLE 2

| Property | VB1-1 | B1-2 | B1-3 | B1-4 | B1-5 | B1-6 | B1-7 |
|---|---|---|---|---|---|---|---|
| Cream time [s] | 24 | 40 | 20 | 12 | 19 | 15 | 24 |
| Fiber time [s] | 71 | 103 | 60 | 35 | 54 | 44 | 65 |
| Rise time [s] | >280 | >240 | 230 | 120 | 160 | 143 | 224 |
| Apparent density | 390 | 320 | 296 | 338 | 370 | 373 | 375 |
| [g/L] | | | | | | | |
| Flex time [min] | >8 | 7:30 | >7 | 4:15 | 6:30 | 6:00 | >8 |
| Demolding time | 6 | 6 | 6 | 6 | 6 | 6 | 6 |
| [min] | | | | | | | |
| Density [g/l] | 689 | 622 | 667 | 678 | 674 | 686 | 664 |

The best results in a polyesterol (b1)-based boot were achieved using polyurethane systems having a molar ratio of tertiary amine (e1) to sebacic acid (e2) of 1:0.19 to 0.27. This resulted in sufficient time to fill the boot (cream time more than 15 s) while the systems simultaneously achieved sensible fiber, rise and flex times (less than 7 min). It has also proved advantageous to employ the tertiary amine catalyst in a concentration of 0.3% to 0.5% by weight based on the components (b) to (f).

### EXAMPLE 2 (polyetherol (b2)-based)

The following compounds were employed:
Iso a-2: isocyanate prepolymer from BASF based on 4.4-MDI, modified isocyanates and a mixture of polyetherols having a functionality of 2 and an OH number of 29.5 mg KOH/g with dipropylene glycol as an additive
Polyetherol (b2-1): Propylene glycol-started polyether polyol having an OH number of 29.5 and predominantly primary OH groups (composition 81.1% by weight propylene oxide, 18.5% by weight ethylene oxide with an OH number of 29.5 mg KOH/g)
Polyetherol (b2-2): Glycerol-started polyether polyol having an OH number of 35 and predominantly primary OH groups (composition 84.4% by weight propylene oxide, 13.3% by weight ethylene oxide with an OH number of 35 mg KOH/g)
KV c-2: 1,4-butanediol
Cat e1-2: pentamethyldipropylenetriamine
Cat e2-1: triethylenediamine (25.5% by weight) in ethylene glycol (59% by weight), sebacic acid (13.5% by weight) and water (2% by weight)
Cat e2-2: triethylenediamine (33.7% by weight) in ethylene glycol (50.8% by weight), sebacic acid (13.5% by weight) and water (2% by weight)
Cat e2-3: triethylenediamine (19.5% by weight) in ethylene glycol (65.0% by weight), sebacic acid (13.5% by weight) and water (2% by weight)
Cat e3-1: dimethyltin carboxylate
Additive f-1: polysiloxane silicone

TABLE 3

| % by weight | B2-1 | B2-2 | B2-3 | B2-4 | B2-5 | B2-6 | B2-7 |
|---|---|---|---|---|---|---|---|
| Polyol b2-1 | 42.00 | 42.00 | 42.00 | 42.00 | 42.00 | 42.00 | 42.00 |
| Polyol b2-2 | 46.02 | 46.02 | 46.02 | 46.02 | 46.02 | 46.02 | 46.02 |
| KV c-2 | 9.00 | 9.00 | 9.00 | 9.00 | 9.00 | 9.00 | 9.00 |
| Cat e1-2 | 0.30 | 0.30 | 0.30 | 0.30 | 0.30 | 0.50 | 0.70 |
| Cat e2-1 | 2.00 | 2.20 | 2.40 | | | 2.40 | 2.40 |
| Cat e2-2 | | | | 2.40 | | | |
| Cat e2-3 | | | | | 2.40 | | |
| Cat e3-1 | 0.03 | 0.03 | 0.03 | 0.03 | 0.03 | 0.03 | 0.03 |
| Amine/sebacic | 1:0.20 | 1:0.22 | 1:0.23 | 1:0.18 | 1:0.28 | 1:0.20 | 1:0.18 |
| acid molar ratio | | | | | | | |
| % by wt Amine* | 0.8 | 0.86 | 0.91 | 1.20 | 0.77 | 1.1 | 1.3 |
| Additive f-1 | 0.30 | 0.30 | 0.30 | 0.30 | 0.30 | 0.30 | 0.30 |
| Water | 0.35 | 0.35 | 0.35 | 0.35 | 0.35 | 0.35 | 0.35 |
| MR to Iso a-2 | 100/92 | 100/88 | 100/90 | 100/94 | 100/99 | 100/96 | 100/96 |

*based on the components (b) to (f)

TABLE 4

| Property | B2-1 | B2-2 | B2-3 | B2-4 | B2-5 | B2-6 | B2-7 |
|---|---|---|---|---|---|---|---|
| Cream time [s] | 20 | 18 | 17 | 15 | 23 | 16 | 16 |
| Fiber time [s] | 47 | 49 | 48 | 45 | 61 | 46 | 45 |
| Rise time [s] | 101 | 104 | 101 | 90 | 120 | 95 | 98 |
| Apparent density | 472 | 454 | 432 | 421 | 443 | 408 | 398 |
| [g/L] | | | | | | | |
| Flex time [min] | 5:30 | 5:30 | 4:30 | 4:15 | 6:00 | 4:15 | 4:15 |
| Demolding time | 6 | 6 | 6 | 6 | 6 | 6 | 6 |
| [min] | | | | | | | |
| Density [g/l] | 704 | 693 | 699 | 703 | 687 | 680 | 689 |

The best results in a polyetherol (b2)-based boot were achieved using polyurethane systems having a molar ratio of tertiary amine (e1) to sebacic acid (e2) of 1:0.19 to 0.27. This resulted in sufficient time to fill the boot (cream time more than 15 s) while the systems simultaneously achieved sensible fiber, rise and flex times (less than 6 min). It has also proved advantageous to employ the tertiary amine catalyst (e1) in a concentration of 0.8% to 1.2% by weight based on the components (b) to (f).

1. A process for producing a polyurethane boots boot wherein
a) organic polyisocyanates are mixed with
b) polyols,
c) chain extender,
d) blowing agent,
e) catalyst and
f) optionally other auxiliaries and/or additives
to afford a reaction mixture and in only one injection introducing the reaction mixture into a mold comprising a sole and an upper of the mold and allowed to react to form the polyurethane boot, wherein at least one catalyst comprising a tertiary amine and sebacic acid is employed in a molar ratio of tertiary amine to sebacic acid of 1:0.19 to 0.27.

2. The process according to claim 1, wherein an MDI is used as polyisocyanate a).

3. The process according to claim 1, wherein a polyesterol (b1) is used as polyol b).

4. The process according to claim 3, wherein the polyester polyol (b1) is obtainable by condensation of aliphatic dicarboxylic acids having 4 to 10 carbon atoms with a difunctional and/or trifunctional aliphatic alcohol.

5. The process according to claim 3, wherein as tertiary amine e) triethylenediamine is employed in an amount of 0.3% to 0.5% by weight based on the components b) to f).

6. The process according to claim 1, wherein a polyetherol (b2) is used as polyol b).

7. The process according to claim 6, characterized in that a propylene glycol-started and/or glycerol-started polyetherol is employed as polyetherol (b2).

8. The process according to claim 6, wherein as tertiary amine e) triethylenediamine and pentamethyldipropylenetriamine is employed in an amount of 0.8% to 1.2% by weight based on the components b) to f).

9. The process according to claim 1, wherein water is employed as the blowing agent.

10. A polyurethane boot obtainable by a process according to claim 1.

11. The polyurethane boot according to claim 10, wherein the boot is a polyurethane integral foam having a density of 150 to 950 g/L.
